(19) United States
(12) Patent Application Publication
(10) Pub. No.: US 2011/0299908 A1
(43) Pub. Date: Dec. 8, 2011

(54) TAPE PRINTING SYSTEM AND INPUT DEVICE

(75) Inventors: Yoshihiko SUGIMURA, Nagoya-shi (JP); Hajime Okochi, Inazawa-shi (JP)

(73) Assignee: BROTHER KOGYO KABUSHIKI KAISHA, Nagoya-shi (JP)

(21) Appl. No.: 13/113,372

(22) Filed: May 23, 2011

(30) Foreign Application Priority Data
Jun. 2, 2010 (JP) 2010-126531

(51) Int. Cl. B41J 5/00

(52) U.S. Cl. 400/472

(57) ABSTRACT

A tape printing system includes an input device, at least consisting of a key input unit and a display, and a printing device, consisting of a thermal head and a head driving circuit in separate from the input device. Further, there are plural kinds of key input units 1 and those or displays 2 so that plural kinds of tape printing systems 100 can be created by combining any one of the plural kinds of key input units and any one of plural kinds of displays.

### CROSS REFERENCE TO RELATED APPLICATIONS

The present application claims priority from Japanese Patent Application No. JP 2010-126531 which was filed on Jun. 2, 2010, the disclosure of which is incorporated herein by reference in its entirety.

### TECHNICAL FIELD

The disclosure relates to a tape printing system that includes a key input unit, a display and a printing unit.

### BACKGROUND

There have conventionally been proposed ideas to realize a tape printing system including a key input unit, a display and a printing unit in a form of an independent tape printing apparatus.

Conventional printing devices are generally configured such that printing performance is made higher standard in proportion to higher standard of input performance design. Under the situation, a user may be forced to buy a model of which input performance is higher standard than he/she desires so as to surely get high standard of printing performance the user desires. In that case, the high standard of input performance is unwanted one for the user who only desires high standard of printing performance and essential standard of input performance for the printing device.

For instance, in case a user puts his/her highest priority to compatibility to a wide printing medium and such models are always restricted to models with high standard of input performance (i.e., models with many kinds of input keys), the user who desires the compatibility to a wide printing medium and essential input performance of a printing device is forced to buy one with higher standard of input performance than he/she desires.

### SUMMARY

The disclosure intends to provide a tape printing system and an input device of the tape printing system, capable of reducing user's burden in key input operations and diversifying choices with respect to standards of input performance, namely designs of key input units etc.

To achieve the object of the disclosure, there is provided a tape printing system including: an input device that at least includes a key input unit consisting of plural keys and a display for indicating data inputted through the key input unit; and a printing device that includes a printing unit for printing out print data inputted with the key input unit onto a long length of a printing medium, the printing device being installed separately from the input device, wherein the tape printing system is compatible with plural kinds of input devices and wherein each of the plural kinds of input devices is specified by a combination of one of plural kinds of key input units and one of plural kinds of displays, the plural kinds of key input units being classified by configuration of the plural keys and the plural kinds of displays being classified by display capacity thereof.

### BRIEF DESCRIPTION OF THE DRAWINGS

FIG. 1 is a block diagram illustrating control configuration of a tape printing system directed to an embodiment;

FIG. 2 is a view exemplarily showing kinds of key input units, those of displays and those of editing programs;

FIG. 3 is a table indicating functions available to each of plural kinds of editing programs;

FIG. 4 shows examples of input devices;

FIG. 5 shows examples of inherent information;

FIG. 6 exemplarily shows functions available to each of plural kinds of input devices in case a multifunction-performable editing program is installed therein; and

FIG. 7 is a flowchart of a printing process directed to the present embodiment.

### DETAILED DESCRIPTION

A detailed description of an exemplary embodiment of a tape printing system directed to the disclosure will be given referring to the accompanying drawings.

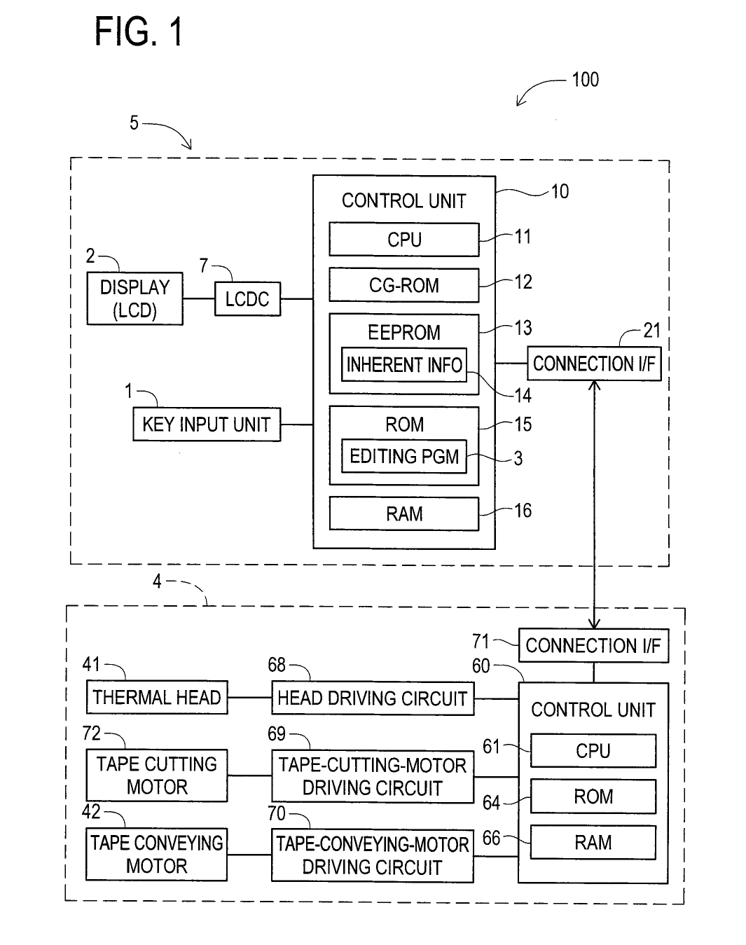

As shown in FIG. 1, a tape printing system 100 directed to the present embodiment consists of a printing device 4 and an input device 5. The input device 5 includes a key input unit 1 and a display 2 that is a liquid crystal display (LCD). The printing device 4 includes a thermal head 41, a tape conveying motor 42, etc., and carries out printing on a printing medium, namely, on a tape. A connection interface 21 for the input device 5 and a connection interface 71 for the printing device 4 are connected to each other, which enables the printing device 4 and the input device 5 to exchange data. Thereby, the printing device 4 can receive printing data from the printing device 5. It is to be noted that communication between the printing device 4 and input device 5 is made feasible with wire communication standard such as USB cable, etc. or wireless communication standard such as infrared transmission, Bluetooth™, etc.

First, there will be described on the printing device 4.

The printing device includes a cassette accommodating portion (not shown), the thermal head 41, the tape conveying motor 42, etc., inside. The cassette accommodating portion is configured to accommodate a tape cassette in a replaceable manner. A tape cassette houses inside a set of an ink ribbon, a double-sided adhesive tape one side of which is covered with a release paper and a surface tape.

The printing device 4 controls the tape conveying motor 42 to drive a conveying roller (not shown) arranged inside the cassette accommodating portion, thereby each tape inside the tape cassette is drawn and conveyed to pass through a contact-state path between the thermal head 41 and a platen roller (not shown). While the tape is being conveyed, the printing device 4 controls the thermal head 41 to drive properly based on printing data and carries out printing on a surface tape that moves together with an ink ribbon. After the printing-applied surface tape and a double-sided adhesive tape are pasted together in a laminated state, the printing device 4 controls a tape cutting motor 72 to drive tape cutting mechanism so as to cut off the laminated-state tape.

The printing device 4 includes a control board (not shown) inside. In the control board, there are built a control unit 60, a head driving circuit 68, a tape-cutting-motor driving circuit 69 and a tape-conveying-motor driving circuit 70. The control unit 60 consists of a CPU 61, a ROM 64 and a RAM 66. The control unit 60 is connected to the head driving circuit 68, the tape-cutting-motor driving circuit 69 and the tape-conveying-motor driving circuit 70 and the communication interface 71.

The CPU 61 is a central processing unit that plays a primary role for various kinds of system control of the printing device 4. Executing various programs stored in the ROM 64, the CPU 61 carries out printing control of print data transmitted from the input device 5.

The ROM 64 stores various control programs and data. Specifically, the CPU 61 executes those control programs so as to drive the thermal head 41, the tape cutting motor 72 and the tape conveying motor 42 through the head driving circuit 68, the tape-cutting-motor driving circuit 69, the tape-conveying-motor driving circuit 70, respectively.

The RAM 66 is a memory unit that temporarily stores an operation result of the CPU 61. The RAM 66 also stores printing data transmitted from the input device 5 via the communication interface 71.

The head driving circuit 68 is a circuit for controlling operation manners of the thermal head 41. Specifically, the head driving circuit 68 serves to supply a driving signal to the thermal head 41, based on a control signal from the CPU 61. In this connection, the head driving circuit 68 controls to energize and de-energize each of heater elements based on a strobe number associated with each heater element in a manner of comprehensive control of the thermal head 41. The tape-cutting-motor driving circuit 69 serves to supply a driving signal to the tape cutting motor 69 in response to a control signal from the CPU 61. The tape-conveying-motor driving circuit 70 serves to supply a driving signal to the tape conveying motor in response to a control signal from the CPU 61.

Next, there will be described on the input device 5. To be described later, there will be exemplarily described on eight variations of the input devices 5, namely, an input device 5A through an input device 5H each of which includes the similar control configuration shown in FIG. 1 as fundamental configuration.

The input device 5 includes a key input unit 1, a display 2, a liquid crystal display controller (LCDC) 7 and a connection interface 27. A control unit 10 of the input device 5 consists of a CPU 11, CG-ROM 12, an EEPROM 13, a ROM 15 and a RAM 16.

The CPU 11 is a central processing unit that plays a primary role for various kinds of system control of the input device 5. Executing an editing program 3 stored in the ROM 15, the CPU 11 creates print data (image data made up of units of dot data) based on characters and symbols inputted with character input keys constituting the key input unit as well as dot patterns stored in the CG-ROM 62.

The CG-ROM 62 is a character generator memory wherein image data of to-be-printed characters and signs are associated with code data and stored in dot patterns. The EEPROM 13 is a non-volatile memory that allows data write for storing therein and deletion of stored data therefrom. The EEPROM 13 stores various setting made by a user for the input device 5. The EEPROM 13 also stores inherent information 14 to be described later. The inherent information 14 corresponds to pieces of information with respect to editing functions that are feasible with an input device 5.

The ROM 15 stores an editing program 3 to be executed by the CPU 11 when creating print data that is dot pattern data based on information of characters and symbols inputted with the key input unit 1.

The RAM 16 includes a buffer that temporarily stores print data created and edited through execution of the editing program by the CPU 11.

The control unit 10 is connected to the connection interface 21. Therefore, the control unit 10 can exchange data with the printing device 4 through the connection interface 21. The control unit 10 is also connected to the key input unit 1 and the LCDC 7. The control unit 10 controls indication patterns to be indicated in the display 2 (LCD) through the LCDC 7.

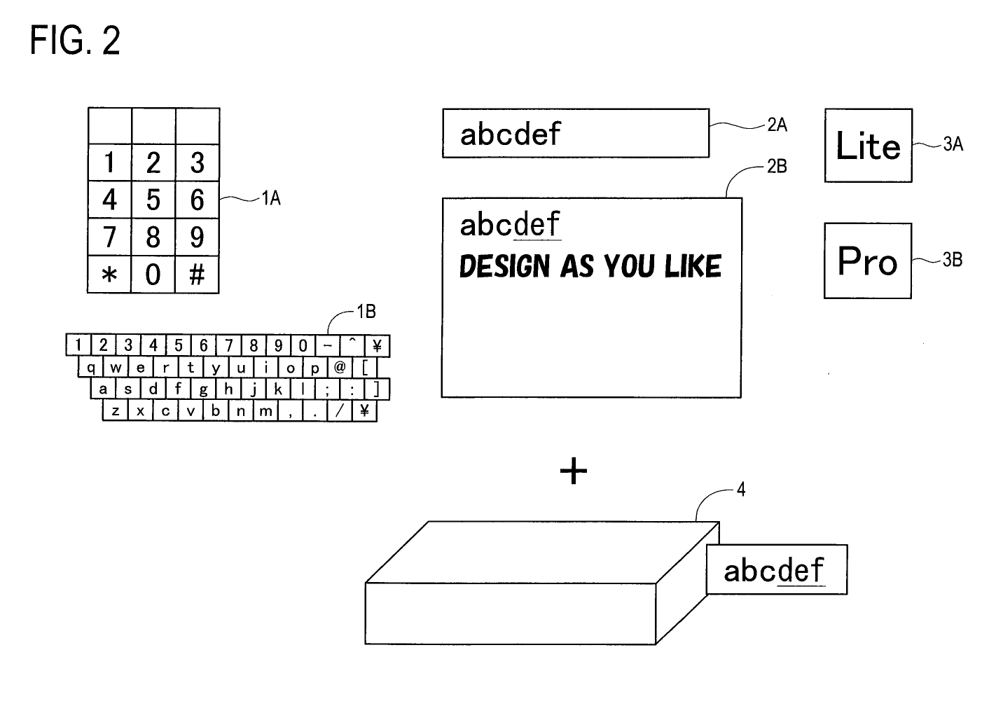

Next, there will be described on the key input unit 1 of the input device 5, the display 2 and the editing program 3 stored in the ROM 15 by referring to FIG. 2.

As shown in FIG. 2, regarding the key input unit 1, there are two kinds thereof, namely, a key input unit 1A and a key input unit 1B. The key input unit 1A is a ten key type consisting of 0 to 9 of numeral keys, a (*) symbol key and a (#) symbol key only while the key input unit 1B is a full key type consisting of alphabet keys (twenty six of keys for alphabets), sign keys including arithmetic symbol keys in addition to the 0 to 9 of numeral keys.

In the foregoing descriptions, performance level of a key input unit 1 is defined by the number of keys constituting the key input 1. In this context, the key input unit 1B is defined higher performance than the key input unit 1A.

Regarding the display 2, there are also two kinds thereof, namely, a display 2A and a display 2B. The display 2A is a character LCD capable of indicating a predetermined length of character string or symbol string in a single line (e.g., 15 characters at maximum within a single line and a 7×5 dot matrix for each character). The display 2B is a graphic LCD capable of indicating both characters and graphical objects within the entirety of the display thereof.

In the foregoing descriptions, performance level of a display 2 is defined by its display capacity and resolution. In this context, the display 2B is defined higher performance than the display 2A.

Regarding the editing program 3, there are two kinds thereof, namely, an essential-function-performable editing program 3A and a multifunction-performable editing program 3B.

In the foregoing descriptions, performance level of an editing program 3 is defined by the number performable functions with respect to creating and editing print data (termed as editing function, hereinafter). In this context, the multifunction-performable editing program 3B is defined higher performance than the essential-function-performable editing program 3A.

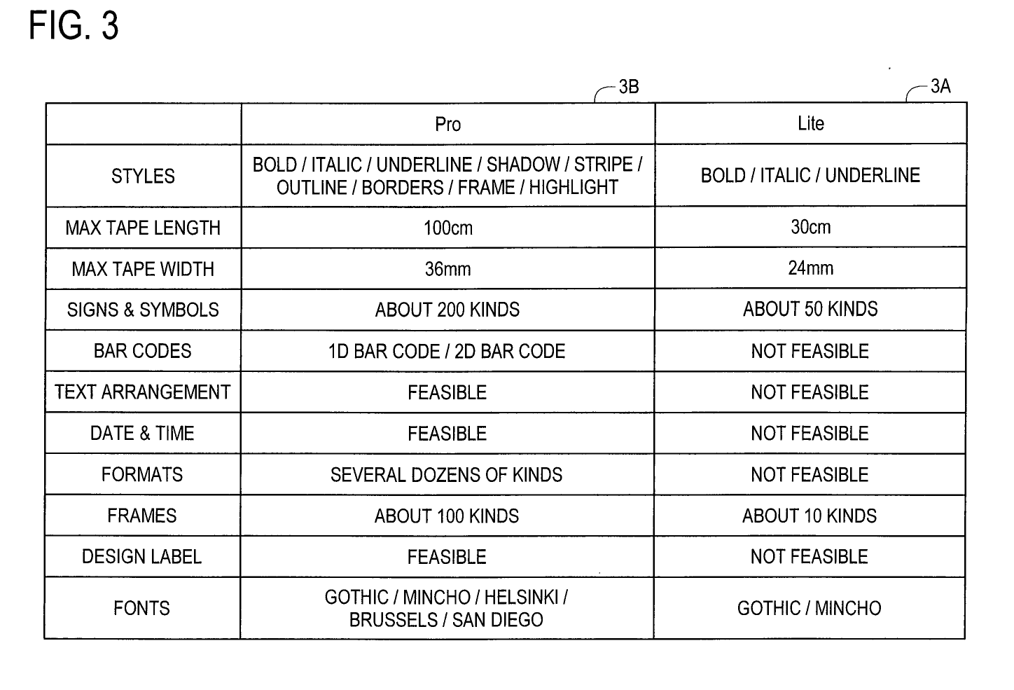

Next, there will be exemplarily described on editing functions of the essential-function-performable editing program 3A and those of the multifunction-performable editing program 3B by referring to FIG. 3.

As shown in FIG. 3, regarding editing functions of “styles”, the multifunction-performable editing program 3B is capable of executing nine editing functions, namely: bold; italic; underline; shadow; stripe; outline; borders; frame; and highlight) whereas the essential-function-performable editing program 3A is capable of exercising three editing functions, namely: bold; italic; and underline.

Regarding editing functions of “maximum tape length” and those of “maximum tape width”, the multifunction-performable editing program 3B is compatible with tape creation with significantly longer length and wider width in comparison with the essential-function-performable editing program 3A.

Regarding editing functions of “signs and symbols”, the multifunction-performable editing program 3B is capable of serving about 200 kinds of signs and symbols whereas the essential-function-performable editing program 3A is capable of serving about 50 kinds of those.

Regarding editing functions of “bar codes”, the multifunction-performable editing program 3B is capable of creating a 1D bar code and a 2D bar code whereas the essential-function-performable editing program 3A is capable of creating neither a 1D bar code nor a 2D bar code.

In FIG. 3, the editing functions termed as “text arrangement” specifically mean editing functions to apply a peculiar arrangement manner to a text string initially arranged in an ordinary manner in a horizontal or vertical direction arrangement, i.e., arranging texts on a curve, arranging texts rotated at predetermined angle. In this connection, the multifunction-performable editing program 3B is configured to contain the editing functions of “text arrangement” whereas the essential-function-performable editing program 3A is not configured to contain those of “text arrangement”.

In FIG. 3, the editing functions termed as “date and time” specifically mean editing functions to print data and time at the moment of printing together with inputted characters. In this connection, the multifunction-performable editing program 3B is configured to contain the editing functions of “date and time” whereas the essential-function-performable editing program 3A is not configured to contain those of “date and time”.

In FIG. 3, the editing functions termed as “formats” mean editing functions to print a greeting with an illustration or a decorative frame. In this connection, the multifunction-performable editing program 3B is capable of printing several dozen kinds of formats whereas the essential-function-performable editing program 3A is not capable of printing any “formats”.

In FIG. 3, the editing functions termed as “frame patterns” mean editing functions to enclose inputted characters with various decorative frames. In this connection, the multifunction-performable editing program 3B is capable of serving about 100 kinds of decorative frame patterns whereas the essential-function-performable editing program 3A is capable of serving about 10 kinds of decorative frame patterns.

In FIG. 3, the editing functions termed as “design label” mean editing functions to print a sophisticated design label. In this connection, the multifunction-performable editing program 3B is capable of printing various design labels whereas the essential-function-performable editing program 3A is not capable of printing any design labels.

Finally, regarding the editing functions termed as “font”, the essential-function-performable editing program 3A is configured to contain less kinds of “font” than the multifunction-performable editing program 3B.

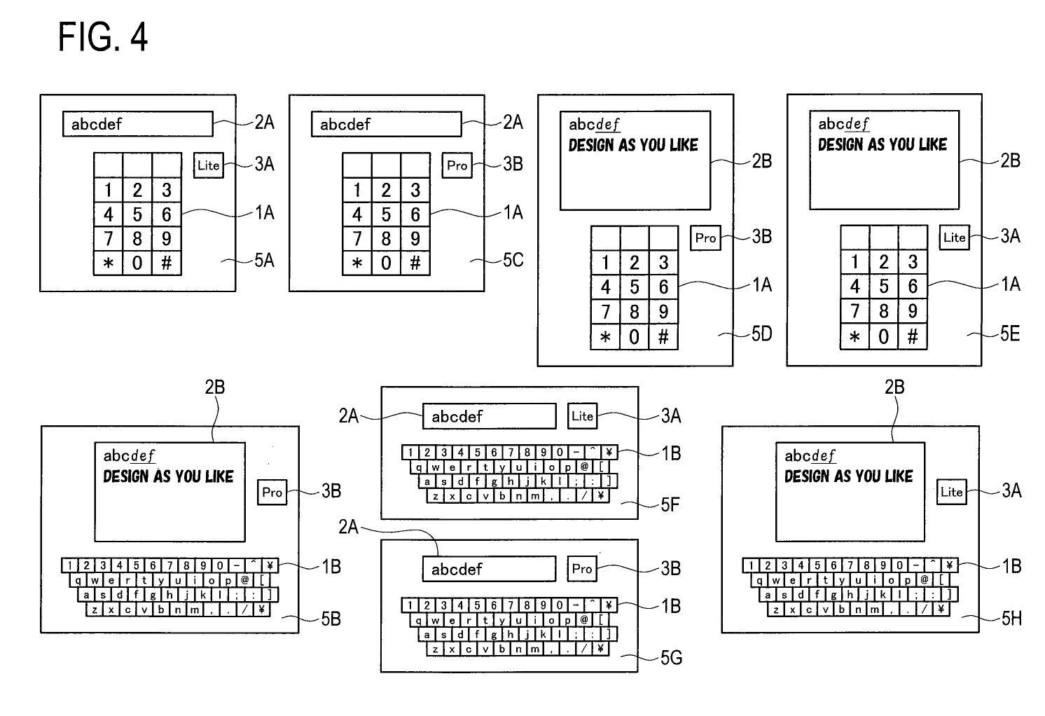

FIG. 4 exemplarily shows examples of eight kinds of input devices 5 (namely input devices 5A through 5H) practicable as the tape printing system 100 directed to the present embodiment. The kinds of input devices 5 are defined by combining each one of three essential components: one of the above-described two kinds of key input units 1 (key input unit 1A, key input unit 1B); one of the above-described two kinds of displays 2 (display 2A, display 2B); and one of the above-described two kinds of editing program 3 (essential-function-performable editing program 3A, multifunction-performable editing program 3B). That is, regarding the tape printing system 100 directed to the present embodiment, a user can select an input device 5 with his/her desired performance standards from the eight kinds. For instance, an input device 5F or 5G may be favorable for a user who wishes to input characters quickly with the key input unit 1B that has many keys while satisfying with the display 2A that indicates only a single line. Further, for instance, the input device 5G may be rather favorable than the input device 5F in case the user wishes the input device to serve the editing functions of “bar codes” that are excluded functions of the multifunction-performable editing program 3B.

It is to be noted that not all the editing functions of the multifunction-performable editing program 3B (refer to FIG. 3) can be executed with the input devices 5B, 5C, 5D and 5G despite that those input devices each employ the multifunction-performable editing program 3B. Even though the multifunction-performable editing program 3B inherently contains all of the editing functions, some of them are made invalid to execute due to configuration restriction of the combined key input unit 1 and the combined display 2, i.e., it depends which one of the two kinds of key input units 1 (key input unit 1A, key input unit 1B) and which one of the two kinds of displays 2 (display 2A, display 2B) are combined.

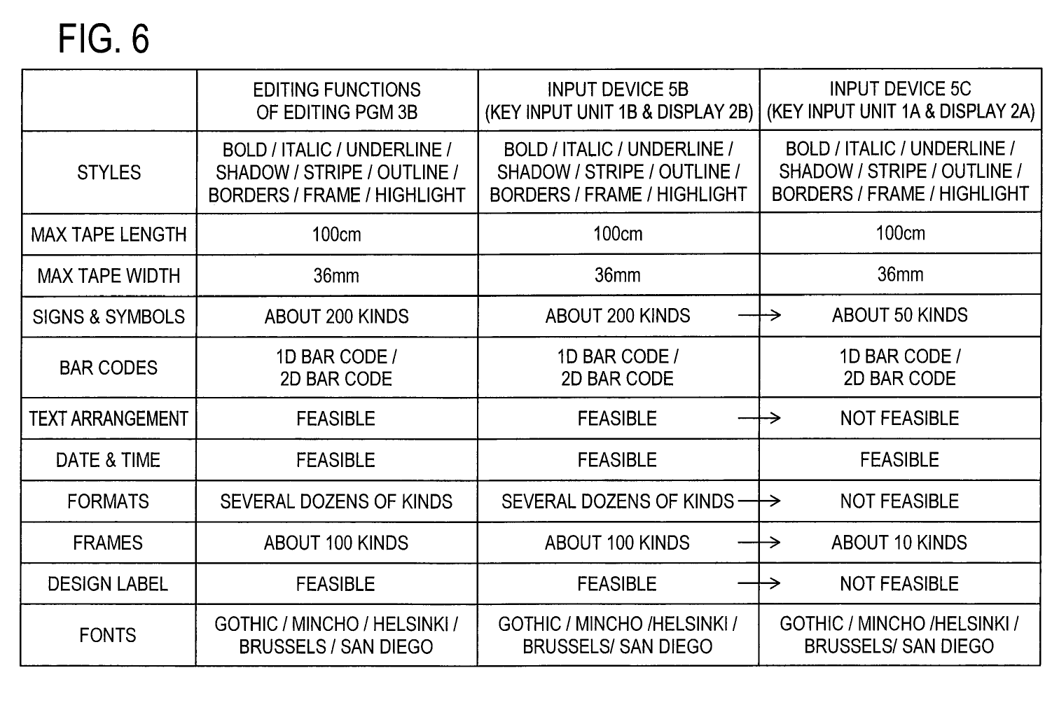

For instance, the input device 5B consists of the full-key-type key input unit 1B, the graphic-LCD-type display 2B and the multifunction-performable editing program 3B wherein all the inherent editing functions of the multifunction-performable editing program 3B are made effective to execute with the input device 5B (refer to FIG. 6).

Here will be described on editing functions of the input device 5 in case the input device 5 employs the display 2A (i.e., the single line character LCD with low resolution). As already described, the editing functions termed as “text arrangement” mean editing functions to apply a peculiar arrangement manner to a text string initially arranged in an ordinary manner in a horizontal or vertical direction arrangement, i.e., arranging texts on a curve, arranging texts rotated at predetermined angle. Therefore, the display 2A may not be able to indicate various patterns of text arrangement and a user may not be able to choose a desired text arrangement manner.

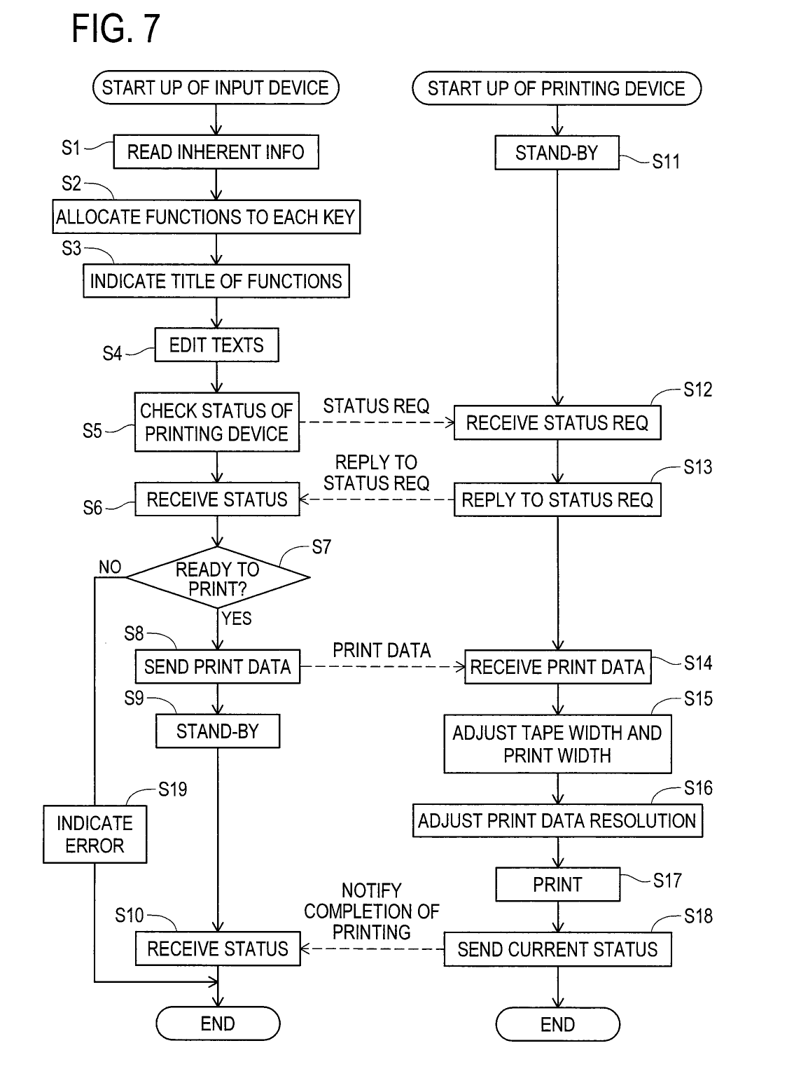

Further, input device 5 with the display 2A may not be able to execute printing of design label, either. Also, patterns of decorative frames the display 2A can indicate are restricted due to its spatial capacity. Accordingly, in the cases of the input device 5C and the input device 5G both employing the display 2A and the multifunction-performable editing program 3B, some of the editing function available to the multifunction-performable editing program 3B is made invalidated to execute through a later-described process based on inherent information 14 (refer to FIG. 7).

Further, the number of signs and symbols that can be input with the ten-key-type key input unit 1A may be restricted more in comparison with those with the full-key-type key input unit 1B. In the cases of the input device 5C and the input device 5D both employing the key input unit 1A and the multifunction-performable editing program 3B, at least one of the signs and symbols printable with the multifunction-performable editing program 3B cannot be printed due to performance restriction of the key input unit 1A.

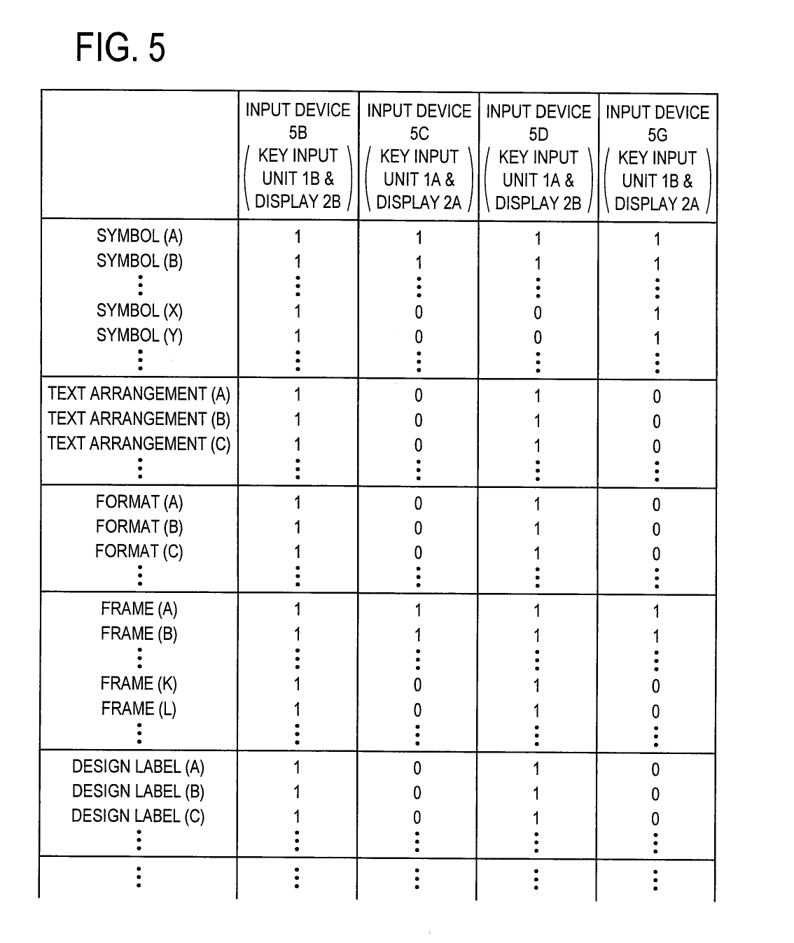

Next, there will be described on the inherent information 14 to be stored in the EEPROM 13 of respective kinds of input device 5 (input device 5A through 5H). As shown in FIG. 5, the inherent information 14 directed to the present embodiment is constituted by significant number of flags, etc. More specifically, the inherent information 14 indicates editing functions feasible with each of input devices 5A through 5H, regardless the kinds of editing programs 3 employed by of each of input devices 5A through 5H. The inherent information 14 is stored in the EEPROM 13 when respective kinds of the input device 5, namely the input devices 5A through 5H are shipped from a factory.

In the example shown in FIG. 5, a flag “1” and a flag “0” respectively represent an editing function feasible with the input device 5 and an editing function not feasible with the input device, respectively.

FIG. 5 specifically shows inherent information 14 about editing function feasibility depends on a kind of the key input unit 1 and that of the display 2 (i.e., inherent information 14 about editing functions of “characters and symbols”, “text arrangement”, “formats”, “frame patterns” and “design label”). However, the inherent information 14 is not restricted to the example shown in FIG. 5. In other words, the inherent information 14 may include and indicate feasible and not feasible with respect to all the editing functions that can be grasped at the time of shipment from a factory.

In the case of the example shown in FIG. 5, the key input unit 1B that has many keys is made capable of inputting any of available symbols such as “symbol (A)”, “symbol (B)” . . . “symbol (X)” and “symbol (Y)”. Accordingly, regarding the inherent information 14 of two kinds of the input devices 5 employing the key input unit 1B (namely the input device 5B and the input device 5G), all the flags of “symbol (A)”, “symbol (B)” . . . “symbol (X)” and “symbol (Y)” are set to “1”. Meanwhile, in case of the key input unit 1A, inputs of “symbol (A)” and “symbol (B)” are made executable and inputs of “symbol (X)” and “symbol (Y)” not made executable. Accordingly, in the inherent information 14 of the other two kinds of the input devices 5 employing the key input unit 1A (namely the input device 5C and the input device 5D), the flags of “symbol (A)”, “symbol (B)” are set to “1” and the those of “symbol (X)” and “symbol (Y)” are set to “0”.

Further, the display 2B that has a comparatively large display area is made capable of indicating various patterns of text arrangement, formats, decorative frames and design labels. Accordingly, in the inherent information 14 of the other two kinds of the input devices 5 employing the display 2B (namely the input device 5B and the input device 5D), all the flags of editing functions directed text arrangement, formats, decorative frames and design labels are set to “1”. Meanwhile, in case of the character-LCD-type display 2A that can indicate only a single line, any editing functions directed to text arrangement, formats, decorative frames and design labels are not made feasible. Accordingly, in the inherent information 14 of the other two kinds of the input devices 5 employing the display 2A (namely the input device 5C and the input device 5G), all the flags directed to editing functions directed to text arrangement, formats and design labels are set to “0”. Regarding editing functions directed to the decorative frame, the display 2A is not capable of displaying “decorative frame (K)” and “decorative frame (L)” due to functional restriction thereof. Accordingly, in the inherent information 14 of the two kinds of the input devices 5 employing the display 2A (namely the input device 5C and the input device 5G), the flags of “decorative frame (K)” and “decorative frame (L)” are set to “0”.

In the input device 5C, the input device 5D and the input device 5G, by executing the later-described process (refer to FIG. 7), some editing functions originally contained in the multifunction-performable editing program 3B are made invalid to execute due to their employment of function-restricted key input unit 1A and/or display 2A and only editing functions executable even with the function-restricted key input unit 1A and/or the display 2A are made valid to exercise. Consequently, in the input device 5C employing the key input unit 1A and the display 2A, editing functions directed to text arrangement, formats and design label are made invalid to exercise as shown in FIG. 6. Further, through execution of the later-described process (refer to FIG. 7) for the inherent information 14, the number of signs and symbols, that of patterns of decorative frames the input device 5C can print are restricted based on the performance level of the key input unit 1A and that of the display 2A. In this connection, except for editing functions directed to text arrangement, format, design label that are made invalid to execute, other editing functions contained in the multifunction-performable editing program 3B are made valid to execute with the input device 5C. That is, regarding the input device 5C, a user is forced to compromise with the performance to some extent due to functional restriction of the key input unit 1 and the display 2 but can enjoy the desired editing functions owing to employment of the multifunction-performable editing program 3B. As described, the input device 5B employing the key input unit 1B and the display 2B can exercise all the available editing functions of the multifunction-performable editing program 3B.

Next, there will be described on a printing process for the tape printing system 100 directed to the present embodiment by referring to FIG. 7. Here will be also described on a specific example regarding editing function restricting process of the editing program based on the inherent information 14. The printing process is executed with any of the input devices 5A through 5H and the printing device 4.

Firstly, when the input device 5 starts up at step (denoted as S hereinafter) 1, the CPU 11 reads inherent information 14 stored in the EEPROM 13.

After reading the inherent information 14 at S1, the CPU 11 executes allocation of editing functions to each key base on the inherent information read out at S2. At S2, the CPU 11 allocates to each key of the key input unit 1 editing functions of which flags are set to “1” among editing functions available to the editing program 3. The step of allocating editing functions to each key at S2, there are previously excluded editing functions not feasible with the input device 5 due to hardware configuration thereof from choices.

For instance, in the cases of the input device 5C and the input device 5G, the CPU 11 does not allocate to any keys editing functions of “text arrangement”, “formats” and “design label” among all the editing functions of the multifunction-performable editing program 3B (namely, among “styles”, “maximum tape length”, “maximum tape width”, “bar codes”, “text arrangement”, “date and time”, “formats” and “design label” . . . ). Accordingly, in the input device 5C and the input device 5G, the above specified editing functions are excluded from choices of editing functions.

In case the input device is configured to choose one from plural candidates of editing functions indicated in the display 2 with operation of specific keys (i.e., cursor keys, a return key, etc.) instead of depressing a key associated with to-be-chosen editing functions, the process at S2 may be omitted. For instance, in case choosing one from choices of about 200 kinds of signs and symbols contained in the multifunction-performable editing program 3B with keys constituting the key input unit 1A or with keys constituting the key input unit 1B, allocation to each key some of choices directed to printable kinds of sings and symbols of which flags are set to “1” in the inherent information 14 from among all the about 200 kinds of signs and symbols. In that case, signs and symbols associated with respective keys of the key input unit 1A or those of the key input unit 1B can be inputted.

Next, at S3, the CPU 11 indicates in the display 2 plural editing functions of the editing program 3 installed in the input unit 5 as available editing functions. For instance, in case the multifunction-performable editing program 3B is installed in the input device 5, the CPU 11 indicates in the display 2 titles classifying respective editing functions contained in the multifunction-performable editing program 3B (i.e., “styles”, “maximum tape length”, “maximum tape width”, “bar codes” . . . ). In case “styles” is chosen from the titles, the CPU 11 indicates in the display 2 available editing functions constituting the title of “styles” (e.g., “bold”, “italic”, “underline” . . . ). At this moment, the CPU 11 only indicates in the display 2 only editing functions of which flags read out the inherent information 14 at S1 are set to “1”. That is, the CPU 11 excludes from indication in the display 2 with respect to some editing functions of the editing programs 3 based on the inherent information 14.

For instance, in the cases of input device 5B and the input device 5D, the CPU 11 indicates in the display 2B the editing functions titled with “text arrangement”, “format” and “design label” as available setting functions at S3 in accordance with the inherent information as shown in FIG. 5. On the other hand, in the cases of input device 5C and the input device 5G, the CPU 11 excludes the editing functions titled with “text arrangement”, “formats” and “design label” from indication in the display 2A from available editing functions (refer to FIG. 5).

Further, as to inputs of signs and symbols, in the cases of the input device 5C and the input device 5D, the CPU 11 executes the process of S3 in accordance with the inherent information shown in FIG. 5 and excludes from indication in the display 2 with respect to “symbol (X)” and “symbol (Y)”.

It is to be noted that indication manners of available editing functions are not restricted to the above described examples. For instance, detailed available editing functions classified with a certain title may be indicated in case a key allocated at S2 to choose the certain title is inputted. More specifically, in case a key allocated at S2 to choose the title “frames” is inputted, the CPU 11 displays the available patterns of “frames” in the display. In the cases of the input device 5C and the input device 5G, the CPU 11 displays in the display 2A only about 10 kinds of frames out of about 100 kinds of decorative frames inherently contained in the multifunction-performable editing program 3B, in accordance with the inherent information shown in FIG. 5.

Next, at S4, the CPU 11 executes editing of texts in accordance with settings chosen at S3. More specifically, at S4, the CPU 11 creates print data from information such as characters and symbols etc. inputted with the key input unit 1. At the same time, the CPU 11 indicates in the display 2 the information such as characters and symbols etc. inputted with the key input unit 1.

After that, the CPU 11 checks if the input device 5 is connected to the printing device 4 at S5.

Meanwhile, after starting up of the printing device 4, the CPU 61 puts the printing device 4 in a stand-by state and awaits an instruction from the input device 5 at S11.

After confirming that the input device 5 is connected with the input device 5 at S5, the CPU 11 transmits a status request command to the printing device 4 so as to check the status of the printing device 4. The status request command corresponds to an information request command that is to check if the printing device 4 is in printing operation, check if a tape cassette is set in the printing device 4, check if a tape in the tape cassette has long enough for printing, etc.

When the printing device 4 receives the status request command at S12, the CPU 61 transmits status information to the input device 5 at S13. The status information includes a reply to the inquiry included in the status request command. It is to be noted that the status request command may include information about a kind of the tape housed in the tape cassette, etc.

When the input device 5 receives the status information at S6, the CPU 11 determines if the printing device 5 is ready to carry out printing at S7, based on the status information received at S6.

In case the printing device 5 is determined as ready to carry out printing (S7: YES), the CPU 11 transmits print data created and edited at S3 to the printing device 4 at S8. After that, the CPU 11 puts the input device 5 in a stand-by state at S9. In case the printing device 5 is determined as not ready to carry out printing (S7: NO), the CPU 11 indicates an error message in the display 2 at S19.

After the printing device 4 receives the print data at S14, the CPU 61 checks tape width of a surface tape housed in the tape cassette and print width of the print data received at S14, at S15. In case the print width of the print data is wider than that of the surface tape that is actual printing medium of the printing device 4, the CPU 61 adjusts print data size so that width of the print data fits with the tape width of the surface tape.

In case the print width of the print data is narrower than that of the surface tape, the CPU 61 may adjust to widen print data size in proportion to tape width of the surface tape. In case adjusting print data size, it is preferable to properly enlarge print data size so as to take well-proportioned margins in tape width direction for obtaining a handsome tape label.

Shifting the process to S16, the CPU 61 determines if print data resolution is resolution compatible with the printing device 4. In case the print data resolution is lower than the resolution compatible with the printing device 4, the CPU 61 converts print data received at S14 by increasing the number of dots of the print data. For instance, in case the number of dots per line of the received print data is smaller than the number of heating elements of the thermal head 41, the CPU 61 converts the print data so that the number of dots per line thereof is made to increase and coincide with the number the heating elements of the thermal head 41. In case dot density of the obtained print data in the sub scanning direction is smaller than dot density printable with the printing device 4, the CPU 61 converts the print data so as to increase dot density of the print data in the sub scanning direction.

In case dot density of the print data is higher than dot density printable with the printing device 4, the CPU 61 may convert the print data so as to thin out some dots of the print data.

After shifting the process to S17, the CPU 61 controls drive of the thermal head 41 and the tape conveying motor 42 so as to print out the obtained print data. When printing of the print data is finished and the process is shifted to S18, the CPU 61 transmits to the input device 5 current status information so as to notify completion of printing.

In receipt of the status information from the printing device 4 at S10, the input device 5 indicates in the display 2 the completion of printing based on the thus obtained status information.

As described, the tape printing system 100 of the present embodiment consists of the input device 5 that includes the key input unit 1 and the display 2, and the printing device 4 that includes the thermal head 41 and the head driving circuit 68. The input device 5 is installed separately from the printing device 4. Accordingly, the input device 5 is made light in weight. Thereby, the tape printing system 100 can reduce a user's burden in key input operations with holding the input device 5. Further, the plural kinds of key input units 1A, 1B are classified by configuration of the plural keys constituting the key input unit 1 applied thereto, and the plural kinds of displays 2A, 2B are classified by display capacity (resolution and indication area) of the display 2 applied thereto. Further, input device 5 includes the ROM 15 for storing the editing program 3 and the CPU 11 for executing the editing program 3. There are plural kinds of editing programs 3, namely, the essential-function-performable editing program 3A and the multifunction-performable editing program 3B that are so classified depending on the number of editing functions feasible therewith. Further, each of the plural kinds of input devices 5 compatible to the tape printing system 100 is specified by a combination of one of plural kinds of key units 1 (key input units 1A, 1B), one of plural kinds of displays 2 (displays 2A, 2B) and one of plural kinds of editing programs 3 (the essential-function-performable editing program 3A and the multifunction-performable editing program 3B). Since a favorable input device 5 can be chosen from various kinds of input devices 5 (8 kinds of input devices 5A through 5H) based on a combination of a key input unit 1, a display 2 and an editing program 3, the printing system 100 can diversify standards of input performance to be chosen for the input device 5.

Here, the performance for the plural kinds of key input units 1 is defined higher performance as the number of the plural keys increases, performance for the plural kinds of displays 2 is defined higher performance as the display capacity (resolution and indication area) is larger and performance for the plural kinds of editing programs 3 is defined higher performance as the number of editing functions contained therein is larger. Further, the input device 5 stores in the ROM 15 the multifunction-performable editing program 3B in which a large number of editing functions are contained, in case the input device 5 employs a key input unit with high performance and a display with high performance (namely, the key input unit 1B and the display 2B). Regarding editing functions of the multifunction-performable editing program 3B, there may be some editing functions that cannot be executed with the display 1A. Further, when choosing and exercising a desired editing function included in the multifunction-performable editing program 3B, the key input unit 1B consisting of a large number of keys can reduce a user's burden in key input operations more significantly in comparison with the key input unit 1A consisting of a small number of keys. Accordingly, the input device 5 can create and edit print data by making effective use of the multifunction-performable editing program 3B. In case a key input unit 1 with low performance and a display 2 with low performance (namely the key input unit 1A and the display 2A) are employed, the input device 5 stores in the ROM 15 the multifunction-performable editing program 3B that contains a smaller number of feasible editing functions. Therefore, the input device 5 employs the multifunction-performable editing program 3B of number of editing functions is suitable to the performance level of the key input unit 1 and that of the display 2 employed therein so as to balance editing functions of the editing program 3 with performance level of the key input unit 1 and that of the display 2.

Regarding the input devices 5 employing the multifunction-performable editing program 3B (namely, input device 5C, input device 5D and input device 5H), in case some editing functions of the multifunction-performable editing program 3B are made invalid to execute due to the key configuration of the key input unit 1 and/or the display capacity of the display 2, the above-specified input devices 5 each selectively indicate in the display 2 only editing functions that are feasible without influence of the key configuration of the key input unit 1 and/or the display capacity of the display 2 (S1 through S3). In case there are some editing functions made invalid to execute due to restriction of the key configuration of the key input unit 1 and/or the display capacity of the display 2 (namely, capacity restriction of hardware), operational deficiency can possibly occurs even if all the procedural steps are correctly taken to execute the desired editing function. In this connection, in the printing system 100, the input device 5 selectively indicates in the display 2 only editing functions that are feasible without influence of capacity restriction of hardware while editing functions made invalid to execute due to the capacity restrictions are never indicated in the display. That is, the tape printing system 100 can prevent operational deficiency that may occur in case execution of an editing function that exceeds capacity restriction of hardware employed by the input device 5 is attempted. Therefore, a user can create and edit print data with the input device 5 without meeting operational deficiency.

In the tape printing system 100, in case the print width defined with the print data inputted with the input device 5 is wider than the width of the printing medium applied to the printing device 4, the printing device 4 reduces the size of the print data to meet with the width of the printing medium. Therefore, in the tape printing system 100, the input device 5 does not need to previously detect the width of the printing medium set in the printing device 4 before creating and editing the print data. Consequently, the tape printing system enables a user to operate the input device 5 for creating and editing print data at a place away from the printing device 4.

While presently exemplary embodiments have been shown and described, it is to be understood that this disclosure is for the purpose of illustration and that various changes and modifications may be made without departing from the scope of the disclosure as set forth in the appended claims.

Especially, kinds of the key input units, those of displays and those of editing programs are not restricted to the exemplarily-described kinds of those shown in FIG. 1 through FIG. 3, namely, key input units 1 (key input unit 1A, key input unit 1B), displays 2 (display 2A, display 2B), and editing programs 3 (essential-function-performable editing program 3A, multifunction-performable editing program 3B). In the embodiment, there are exemplarily given two kinds of key input units 1, two kinds of displays 2 and two kinds of editing programs 3, however, the number of kinds for respective components is not restricted to two, not mention, more number of kinds may be selective with respect to those constituent elements.

Further, pieces of the inherent information 14 shown in FIG. 14 are merely examples thereof and they do not specify relation among the key input unit, the display and the editing program of the disclosure.

In the present embodiment, information about fonts is stored in the input device so as to allow the input device to create to-be-printed image data (dot data) based on the information about fonts and to transmit the image data to the printing device. However data exchange is not restricted to the above-mentioned manner.

For instance, the information about fonts may be stored in the printing device. In that case, the input device converts information inputted with the key input unit to an ECS/P command and then, transmits the converted command to the printing device. Subsequently, the printing device creates image data based on the thus obtained ESC/P command.

In the present embodiment, the printing device executes the process to adjust print width of print data in accordance with tape width of the tape currently set in the printing device (S15) and the process to adjust dot density of print data to dot density printable with the printing device (S16). However, adjustment processes are not restricted to the above. In the present disclosure, adjustment processes may be made executable with the input device. For instance, the printing device may be configured to previously transmit the printing device information about tape width of the currently used printing medium, printable dot density, etc. With such configuration, the input device can specify information about tape width of the currently used printing medium based on the obtained information. Thereby, the input device can create proper print data depending on conditions of tape width of the printing medium set in to the printing device.

What is claimed is:

1. A tape printing system comprising:
an input device that at least includes a key input unit consisting of plural keys and a display for indicating data inputted through the key input unit; and
a printing device that includes a printing unit for printing print data inputted with the key input unit onto a long length of a printing medium, the printing device being installed separately from the input device,
wherein the tape printing system is compatible with plural kinds of input devices and
wherein each of the plural kinds of input devices is specified by a combination of one of plural kinds of key input units and one of plural kinds of displays, the plural kinds of key input units being classified by configuration of the plural keys and the plural kinds of displays being classified by display capacity thereof.

2. The tape printing system according to claim 1,
wherein the input device further comprises a print-data creating and editing unit that includes:
a storage unit for storing an editing program that makes plural editing functions feasible when creating and editing the print data; and
a control unit for executing the editing program stored in the storage unit,
wherein the tape printing system is compatible with plural kinds of input devices, and
wherein each of the plural kinds of input devices is specified by a combination of one of plural kinds of key input units, one of plural kinds of displays and one of plural kinds of editing programs, the plural kinds of key input units being classified by configuration of the plural keys, the plural kinds of displays being classified by display capacity thereof and the plural kinds of editing programs being classified by number of editing functions contained therein.

3. The tape printing system according to claim 2,
wherein performance for the plural kinds of key input units is defined higher performance as the number of the plural keys increases,
wherein performance for the plural kinds of displays is defined higher performance as the display capacity is larger,
wherein performance for the plural kinds of editing programs is defined higher performance as the number of editing functions contained therein is larger,
wherein the input device stores an editing program with high performance in the storage unit in case the tape printing system employs a key input unit with high performance and a display with high performance, and
wherein the input device stores an editing program with low performance in the storage unit in case the tape printing system employs a key input unit with low performance and a display with low performance.

4. The tape printing system according to claim 2, further comprising a display control unit that controls the display to selectively indicate only editing functions that are feasible with the tape printing system regardless of restriction of key configuration of the key input unit and/or restriction of display capacity of the display in case the editing program contains editing functions made invalid to execute due to the restriction of the key configuration of the key input unit and the restriction of the display capacity of the display.

5. The tape printing system according to claim 3, further comprising a display control unit that controls the display to selectively indicate only editing functions that are feasible with the tape printing system regardless of restriction of key configuration of the key input unit and/or restriction of display capacity of the display in case the editing program contains editing functions made invalid to execute due to the restriction of the key configuration of the key input unit and the restriction of the display capacity of the display.

6. The tape printing system according to claim 1, further comprising an adjustment unit for adjusting a size of the print data to an available size of the printing medium set to the printing device providing for a case that the print width defined with the print data inputted with the input device is wider than the width of the printing medium.

7. The tape printing system according to claim 2, further comprising an adjustment unit for adjusting a size of the print data to an available size of the printing medium set to the printing device providing for a case that the print width defined with the print data inputted with the input device is wider than the width of the printing medium.

8. The tape printing system according to claim 3, further comprising an adjustment unit for adjusting a size of the print data to an available size of the printing medium set to the printing device providing for a case that the print width defined with the print data inputted with the input device is wider than the width of the printing medium.

9. The tape printing system according to claim 4, further comprising an adjustment unit for adjusting a size of the print data to an available size of the printing medium set to the printing device providing for a case that the print width defined with the print data inputted with the input device is wider than the width of the printing medium.

10. The tape printing system according to claim 5, further comprising an adjustment unit for adjusting a size of the print data to an available size of the printing medium set to the printing device providing for a case that the print width defined with the print data inputted with the input device is wider than the width of the printing medium.

11. An input device comprising
a key input unit consisting of plural keys;
a display for indicating data inputted through the key input unit;
a printing device that includes a printing unit for printing print data inputted with the key input unit onto a long length of a printing medium, the printing device being installed separately from the input device,
wherein the input device is applied to a tape printing system compatible with plural kinds of input devices,
wherein the input device further comprises a print-data creating and editing unit that includes:
a storage unit for storing an editing program that makes plural editing functions feasible when creating and editing the print data; and
a control unit for executing the editing program stored in the storage unit, and
wherein each of the plural kinds of input devices is specified by a combination of one of kinds of key input units, one of plural kinds of displays and one of plural kinds of editing programs, the plural kinds of key input units being classified by configuration of the plural keys, the plural kinds of displays being classified by display capacity thereof and the plural kinds of editing programs being classified by number of editing functions contained therein.
